(19) United States
(12) Patent Application Publication
(10) Pub. No.: US 2005/0201925 A1
(43) Pub. Date: Sep. 15, 2005

(54) Process for making hydrogen peroxide

(76) Inventors: Bi Le-Khac, West Chester, PA (US); Roger A. Grey, West Chester, PA (US)

Correspondence Address: LYONDELL CHEMICAL COMPANY, 3801 WEST CHESTER PIKE, NEWTOWN SQUARE, PA, 19073, US

(21) Appl. No.: 10/796,810

(22) Filed: Mar. 9, 2004

(51) Int. Cl. C01B 15/029

(52) U.S. Cl. 423/584

(57) ABSTRACT

A process for making hydrogen peroxide directly from hydrogen and oxygen is disclosed. The process comprises reacting the gases in a solvent in the presence of a catalyst comprising a polymer-encapsulated transition metal. Polymer-encapsulated transition metal catalysts are easy to prepare and use, they are easy to recover and reuse, and they provide good conversions to hydrogen peroxide.

### FIELD OF THE INVENTION

The invention relates to a catalytic process for making hydrogen peroxide directly from hydrogen and oxygen.

### BACKGROUND OF THE INVENTION

The world consumes more than 3.5 billion pounds per year of hydrogen peroxide. Demand should continue to grow because of its environmental advantages. Among the most important industrial uses are its use in water treatment and as a chlorine replacement for bleaching pulp and paper. Hydrogen peroxide is also a valuable oxidizing agent for organic synthesis. For example, it has been used with titanium zeolites to convert propylene to propylene oxide, benzene to phenol, cyclohexanone to the corresponding oxime, and cyclohexanone to ε-caprolactone. At present, the only process practiced commercially on a large scale to make hydrogen peroxide involves anthraquinone autooxidation (see, e.g., U.S. Pat. Nos. 4,428,923 and 6,524,547). The process requires numerous reactor and purification sections, uses a large volume of solvent, and provides a less-than-ideal yield of hydrogen peroxide.

Hydrogen peroxide can also be made by a direct reaction of hydrogen and oxygen in the presence of a suitable catalyst, but so far, low reaction rates, poor selectivities, and potentially explosive reactants have prevented direct H₂O₂ manufacture from becoming a commercial reality. Considerable interest remains, however, in identifying safe, economic routes.

Known methods of making hydrogen peroxide from hydrogen and oxygen use supported transition metal compounds, especially platinum group metals. A wide variety of inorganic and organic supports have been identified, including activated carbon (U.S. Pat. No. 6,649,140), fluorinated carbons (U.S. Pat. No. 5,846,898), sulfonic acid-functionalized carbon (U.S. Pat. No. 6,284,213), silicas, aluminas (U.S. Pat. No. 5,961,948), and polymer fibers (U.S. Pat. No. 6,375,920), among others. A variety of techniques are used to apply the transition metals to a surface of the support. Supporting metals by conventional methods often produces catalysts with lower than desirable activities.

Recently, Professor Shu Kobayashi reviewed a new kind of catalyst based on a technique called “microencapsulation” (see Chem. Commun. (2003) 449 and references cited therein; Angew. Chem., Int. Ed. 40 (2001) 3469; J. Am. Chem. Soc. 120 (1998) 2985). While polymer encapsulation has been used for years by the pharmaceutical industry to mask taste, impart storage stability, reduce stomach irritation, target delivery, or control release of drugs, benefits of the technique for catalysis are just now being realized. Kobayashi demonstrated that highly efficient catalysts can be made if the metals are enveloped within a thin polystyrene film. Microencapsulated transition metal catalysts and ways to make them are described in the Chem. Commun. article referenced above. These have been used for etherification, olefin dihydroxylation, allylic substitution, Suzuki coupling, and other organic transformations, but apparently not for making hydrogen peroxide.

As noted in the Kobayashi review article, Steven Ley et al. have prepared polyurea-microencapsulated palladium for use as a catalyst in hydrogenations or coupling reactions (see, e.g., Chem. Commun. (2002) 1132 and 1134; and Chem. Commun. (2003) 678), suggesting that the value of microencapsulation for catalysis is not limited to hydrophobic polymers such as polystyrene.

Missing from the literature is any suggestion that polymer-encapsulated transition metals might have value in a process for making hydrogen peroxide directly from hydrogen and oxygen.

### SUMMARY OF THE INVENTION

The invention is a process for making hydrogen peroxide directly from hydrogen and oxygen. The process comprises reacting the gases in a reaction solvent in the presence of a catalyst comprising a polymer-encapsulated transition metal. While “supported” transition metals have long been suggested for use in direct hydrogen peroxide production, the metal traditionally resides on an exposed surface of a solid support. In the process of the invention, the transition metal is encapsulated completely within a thin layer of polymer. Polymer-encapsulated transition metal catalysts are easy to prepare and use, they are easy to recover and reuse, and they provide good conversions to hydrogen peroxide.

### DETAILED DESCRIPTION OF THE INVENTION

The process involves a direct reaction between hydrogen and oxygen gases in the presence of a polymer-encapsulated transition metal catalyst to produce hydrogen peroxide.

Oxygen and hydrogen gases are required. Although any sources of hydrogen and oxygen can be used, molecular oxygen (O₂) and molecular hydrogen (H₂) are preferred. The molar ratio of hydrogen to oxygen (H₂:O₂) used is preferably within the range of about 1:10 to about 10:1. More preferably, the H₂:O₂ ratio is within the range of about 1:2 to about 4:1.

In addition to oxygen and hydrogen, an inert gas carrier may be used. Preferably, the inert gas carrier is a noble gas such as helium, neon, or argon. Nitrogen, methane, and carbon dioxide can also be used. Because it is cheap and readily available, nitrogen is a preferred inert gas carrier. The inert gas carrier advantageously provides a way to keep the oxygen and hydrogen levels outside the explosive limits.

The catalyst includes a transition metal. Suitable transition metals are found in Groups 7-11. The first row of these, for example, includes transition metals from Mn to Cu. Preferred transition metals are Re, Au, and the metals of Groups 8-10. Particularly preferred are Re, Fe, Ru, Co, Rh, Ir, Ni, Pd, Pt, Ag, and Au. The transition metal can be present in any suitable form as long as it is capable of catalyzing the reaction between hydrogen and oxygen gases to make hydrogen peroxide. For example, it may be present as the free metal (e.g., Pt or Pd metal), as a mixture of metals (e.g., Pd—Au, Pd—Pt, or the like), or it may be part of a complex that incorporates the metal or metals and other ligands (e.g, PtCl₂, Pd(NH₃)₄Cl₂, tris(benzylideneacetone)dipalladium(0), or tetrakis(triphenylphosphine)palladium(0)). The transition metal or transition metal complex can be supported on silicas, aluminas, carbons, zeolites (e.g., titanium silicalites), clays, organic polymers such as crosslinked polystyrene, or any other conventional support prior to being encapsulated within a polymer. Other examples of transition metal sources suitable for use include Pd/C, Pt/C, Pd/silica, Pd/alumina, Pd/silicalite, Pd/Y-zeolite, Pd/kaolin, Pd/ZSM-5, Pd on TS-1, Pt on TS-1, Pd—Pt on TS-1, PdCl₂, PtCl₂, Pd(NH₃)₂Cl₂, PdBr₂, Pd(NO₃)₂, palladium(II) acetate, tetrakis(acetonitrile)palladium(II) bis(tetrafluoroborate), tetrakis(acetonitrile)palladium(II) bis(hexafluorophosphate), HAuCl₄, Au₂O₃, RhCl₃, IrCl₃, and the like.

Transition metals catalysts used in the process of the invention are polymer-encapsulated. By “encapsulated,” we mean that the metal or metal complex does not reside on an exposed surface of a support. Instead, it is contained within and is surrounded by a thin layer of polymer. Thus, encapsulation involves entrapping the metal within a polymeric coating. To interact with the transition metal, the hydrogen and oxygen must penetrate this polymer coating.

Polymers suitable for use in making polymer-encapsulated catalysts are homopolymers or random and block copolymers produced by free-radical, ionic, or coordination polymerization of one or more polymerizable monomers. Generally, the polymers are natural or synthetic polymers made by addition or condensation polymerizations. Examples include polystyrenics, polyolefins, polyureas, polyacrylics, polyurethanes, polyesters, polyamides, fluorinated polymers, polysaccharides, polypeptides, polynucleotides, and the like, and mixtures thereof. Particularly preferred are polystyrenics, polyolefins, polyacrylics, and polyureas. The polymers can be generated by bulk, solution, suspension, or emulsion polymerization methods. The polymers can be hydrocarbons, or they can incorporate functional groups such as hydroxyl, amine, phosphine, phosphine oxide, arsine, sulfur, sulfur oxides, fluoroalkyl, alkoxy, silane, siloxy, carboxy, or the like.

There are many suitable ways to encapsulate transition metals within a polymer. Some of these techniques have been used to encapsulate pharmaceuticals to mask taste, impart storage stability, or target drug delivery; others have been used to encapsulate solid pesticide particles. Suitable techniques include, for example, spray-drying, spray-chilling, spray-coating, phase separation and coascervation, injection treatment coating, fluid bed coating, dry-on-dry coating, melt extrusion, vapor deposition, in-situ polymerization, including in-situ interfacial polymerization, and the like. These and other microencapsulation techniques are described in the introductory chapter of Microcapsules and Nanoparticles in Medicine and Pharmacy, M. Donbrow, Ed., pp. 1-14, and references cited therein, and in G. Beestman, “Microencapsulation of Solid Particles,” Controlled-Release Delivery Systems for Pesticides (1999), H. Scher, Ed., pp. 31-54. See also U.S. Pat. No. 6,156,245.

Polymer encapsulation by phase separation/coascervation is one preferred technique. A suitable approach is illustrated by Kobayashi et al. (see Chem. Commun. (2003) 449 and references cited therein; Angew. Chem. Int. Ed. 40 (2001) 3469; J. Am. Chem. Soc. 120 (1998) 2985) with polystyrene as the polymer encapsulant. See also Zairo Gijutsu 3 (1985) 29, and J. Appl. Polym. Sci. 89 (2003) 1966.

In a particularly convenient coascervation approach taught by Kobayashi, polystyrene is dissolved in warm cyclohexane. Tetrakis(triphenylphosphine)palladium(0) is dissolved in the mixture. Upon slow cooling to 0° C., phase separation and capsule formation occur. Hexane is added to harden the microcapsules, which are then isolated, washed, and dried (see, e.g., Examples A-C below).

In-situ polymerization is another preferred technique. The transition metal source is dissolved or suspended in a reaction medium containing monomer(s), an initiator, and other components, and polymerization proceeds to give the polymer-encapsulated transition metal. The monomers can be hydrophilic (e.g., N,N-dimethylacrylamide), hydrophobic (e.g., styrene), or a combination of these. Suitable techniques include bulk, emulsion, suspension, and interfacial polymerizations.

One interfacial method is illustrated by Ley et al. (see Chem. Commun. (2002) 1132 and 1134; and Chem. Commun. (2003) 678) in the preparation of polyurea-encapsulated transition metals. In this example, an organic phase containing polymerizable monomers and the transition metal source is dispersed within an aqueous phase that contains emulsifiers and/or stabilizers. Polymerization occurs at the interface to form microcapsule walls. For another example of in-situ polymerization to generate microcapsules, see Adv. Powder Technol. 13 (2002) 265.

In another in-situ polymerization example, styrene or a mixture of styrene and other ethylenic monomer(s) is polymerized in an aqueous suspension according to well-known techniques in the presence of a soluble or suspended transition metal source. The resulting polymer beads incorporate encapsulated transition metal and are suitable for use in making hydrogen peroxide according to the process of the invention.

In another preferred approach, the polymer incorporates recurring units of a fluorinated monomer. Particularly suitable are fluorinated monomers made by reacting fluorinated alcohols with acrylic ester precursors. These and other suitable fluorinated monomers have been described previously (see Chem. Commun.(2002) 788; Tetrahedron 58 (2002) 3889, Org. Letters 2 (2000) 393, Polym. Degrad. Stab. 67 (2000) 461; and Chem. Commun. (2000) 839.) For example, polymerization of trifluoroethylmethacrylate (from methacryloyl chloride and trifluoroethanol) with styrene gives a flurorinated copolymer. Polymer encapsulation can be effected either in-situ or later by phase separation/coascervation. The hydrophobic fluorinated polymers should provide a favorable environment for generating hydrogen peroxide.

The process of the invention is performed in the presence of a solvent. Suitable solvents dilute the gaseous reactants to a level effective to allow them to safely react to form hydrogen peroxide. Preferably, both hydrogen and oxygen have appreciable solubility in the solvent. Oxygenated solvents are preferred. The oxygenated solvent is preferably a liquid under the reaction conditions and contains at least one oxygen atom. Suitable oxygenated solvents are water, oxygen-containing hydrocarbons (alcohols, ethers, esters, ketones, and the like), liquid or supercritical carbon dioxide, and mixtures thereof. Preferred oxygenated solvents include lower aliphatic alcohols, especially C₁-C₄ alcohols such as methanol, ethanol, isopropyl alcohol, tert-butyl alcohol, and the like, and mixtures thereof. Fluorinated alcohols can also be used. Particularly preferred oxygenated solvents are water, methanol, water/methanol mixtures, and carbon dioxide. When a mixture of methanol and water is used, the molar ratio of methanol to water is preferably within the range of about 1 to about 20, more preferably from about 3 to about 8.

When the process is performed in the liquid phase, it is preferred to use the catalyst in the form of a suspension or fixed bed. The process may be performed using a continuous flow, semi-batch, or batch mode of operation. It is preferred to operate at a total pressure within the range of about 1 to about 200 bars. The reaction is performed at a temperature effective to produce the desired amount of hydrogen peroxide, preferably at temperatures within the range of about 0° C. to about 100° C., more preferably from about 20° C. to about 60° C.

If desired, a protic acid or a salt thereof can be included in small amounts in the reaction mixture. The protic acid can boost selectivity to hydrogen peroxide, maintain a high concentration of hydrogen peroxide in the mixture, and generally help to prevent decomposition of the hydrogen peroxide by the transition metal. Suitable protic acids and salts include, for example, hydrogen bromide, sodium bromide, ammonium bromide, hydrogen chloride, sulfuric acid, phosphoric acid, triflic acid, and the like, and mixtures thereof. When the protic acid is HCl, HBr, or a halide salt, the amount used is preferably within the range of about 0.1 to about 100, more preferably from about 1 to about 10, parts per million based on the amount of reaction mixture. When the protic acid is H₂SO₄, H₃PO₄, triflic acid, and salts thereof, the amount used is preferably within the range of about 100 to about 5000 parts per million based on the amount of reaction mixture. Hydrogen bromide and mixtures of HBr with phosphoric acid are particularly preferred. As Example 6 shows, the use of phosphoric acid with HBr can dramatically boost the concentration of hydrogen peroxide in the product mixture (compare results in Example 5).

Polymer encapsulation provides numerous advantages for catalysts useful for making hydrogen peroxide. First, polymer encapsulation makes it easy to recover the transition metal species. Finely divided transition metals such as Pt/C, Pd/silica, or Pd on TS-1, are often difficult to isolate from other components in a reaction mixture. These fine particles tend to blind filters, which can force a process shutdown. Polymer encapsulation makes the transition metal species easy to recover by ordinary filtration methods (see Example 10, Comparative Examples 11-12, and Table 2 below). Because the catalysts are easily recovered, losses of the expensive transition metal species are minimized. A recovered polymer-encapsulated transition metal should be reuseable without much additional processing. If necessary, however, a spent polymer-encapsulated transition metal catalyst can be ashed to eliminate organic impurities and recover the metal value.

Interestingly, polymer encapsulation has little or no negative impact on the ability of transition metals to catalyze the direct reaction of hydrogen and oxygen to make hydrogen peroxide. Hydrogen, oxygen, and solvent components can penetrate the polymer film and interact with the transition metal to form hydrogen peroxide, and products can migrate from the polymer matrix. As the examples below demonstrate, we successfully made hydrogen peroxide with polymer-encapsulated palladium using a variety of palladium complexes and palladium on titanium silicalite (see Examples 1-7) and generated hydrogen peroxide at levels comparable to the control example, which used palladium on TS-1 with no polymer encapsulation (Comparative Examples 8 and 9).

In sum, polymer-encapsulated transition metal catalysts are easy to prepare and use, they are easy to recover and reuse, and they provide good conversions of hydrogen and oxygen in a process for making hydrogen peroxide.

The following examples merely illustrate the invention. Those skilled in the art will recognize many variations that are within the spirit of the invention and scope of the claims.

### CATALYST PREPARATION EXAMPLES

### Example A

### Preparation of Polystyrene-Encapsulated Palladium Catalyst

Polystyrene beads (5.0 g) are dissolved in cyclohexane (100 g) at 40° C. using an ultrasonic bath. The polystyrene solution is degassed with nitrogen and is transferred to a glove box. Under an argon atmosphere, tris(dibenzylideneacetone)dipalladium(0) (Aldrich, 0.0675 g, enough to give 0.3 wt. % Pd in the encapsulated catalyst) is added to the polystyrene solution with mixing. The solution is kept under argon and is slowly cooled to 0° C. to promote coascervation. Hexanes (250 mL) are then added to harden the capsules. The liquid portion is decanted, and more hexanes (50 mL) are added. The mixture is homogenized using an Omni International S/N GLH-4040 homogenizer (150 volt, 60 Hz) at about 50% power to reduce the particle size. The resulting powder is isolated by filtration and is dried under vacuum at 40° C. The catalyst is a light purple powder. Yield: 4.933 g. Pd: 0.25 wt. %.

### Example B

### Preparation of Polystyrene-Encapsulated Palladium Catalyst

Polystyrene beads (1.0 g) are dissolved in cyclohexane (20 mL) at 40° C. Tetrakis(triphenylphosphine)palladium(0) (Aldrich, 0.2 g) is added, and a clear solution results. Upon cooling the mixture to 0° C., coascervation occurs. Hexanes (50 mL) are added to harden the capsules. The liquid portion is decanted, and the solids are dried under vacuum at 40° C. The dry solids are ground to a powder prior to use. Pd: 0.96 wt. %; P: 1.19 wt. %; mole ratio of P/Pd: 4.26.

### Example C

### Preparation of Polystyrene-Encapsulated (Pd on TS-1)

Polystyrene beads (3.0 g) are dissolved in cyclohexane (60 g) at 50° C. using an ultrasonic bath. A sample of the warm solution (10.5 g) is combined with powdered Pd on titanium silicalite (2.0 g, 0.15 wt. % Pd on TS-1, prepared similarly to Comparative Example E) and mixed at 50° C. for 1 h. Upon cooling the mixture to 0° C., coascervation occurs. Hexanes (20 g) are added to harden the capsules. The liquid portion is decanted, and the solids are resuspended in hexanes (80 g). The mixture is homogenized for about 1 minute and the liquid phase is decanted. The solids are dried under vacuum at 40° C. for about 1 h. The solids are then washed with methanol (80 g) and dried under vacuum overnight. Yield: 2.19 g. Pd: 0.08 wt. %; Ti: 1.7 wt. %.

### Example D

### Preparation of Terpolymer-Encapsulated (Pd on TS-1)

p-Styryldiphenylphosphine (21 g, 0.073 mol), 4-tert-butylstyrene (42 g, 0.26 mol), and N,N-dimethylacrylamide (7.0 g, 0.071 mol) are dissolved in tetrahydrofuran (89 g) in a glass reactor. 2,2′-Azobisisobutyronitrile (AIBN, 0.5 g) is added, and the stirred mixture is heated to 80° C. for about 5 h. The reactor is cooled and the contents are removed. Residual tetrahydrofuran and unreacted monomers are removed by stripping under vaccum. Terpolymer yield: 39.8 g. Mₙ=20,000; M_{w}=1.75; P: 3.4 wt. %; Tg=123.5° C.

A sample of the terpolymer (4.26 g) is dissolved in methyl ethyl ketone (MEK, 20 g) at room temperature. Palladium on spray-dried TS-1 (10 g) is added, and the mixture is stirred until it thickens. The mixture is placed in a vacuum oven and volatiles are slowly removed at 40° C. The residue is then ground to a fine powder and dried for 3 h at 40° C. Yield: 14 g. Pd: 0.07 wt. %; P: 2.3 wt. %.

### Comparative Example E

### Preparation of 0.31 wt. % Pd on Spray-Dried TS-1

Spray-dried TS-1 (112 g; 80 wt. % TS-1 plus silica binder; 1.6% Ti; average particle size about 40 microns) calcined at 550° C. in air is slurried in deionized water (250 g). To this, an aqueous solution of tetraamminepalladium(II) chloride (1.3 g in 90 g of deionized water) is added with mixing over 30 min. The round-bottom flask containing the slurry is turned at about 30 rpm in a 30° C. water bath for 2 h. The slurry is filtered, and the filter cake is washed by reslurrying in deionized water (140 g) and filtering again. The washing is repeated three more times. The solids are air dried overnight and dried under vacuum at 50° C. for 6 h to a constant weight. Pd: 0.31 wt. %; Ti: 1.63 wt. %.

The dried solids are oven-calcined in air by heating from 23 to 110° C. at 10° C./min and holding at 110° C. for 4 h, then heating to 150° C. at 2° C./min and holding at 150° C. for 4 h.

The calcined solids are then transferred to a quartz tube, heated to 50° C., and treated with 5% hydrogen (100 cm³/min) for 4 h. After hydrogen treatment, nitrogen is then passed through the solids for 1 h before cooling to 23° C.

### Comparative Example F

### Preparation of 0.37 wt. % Pd on TS-1 Powder

TS-1 powder (30 g; 2.1 wt. % Ti; ave. particle size about 0.2 μm) calcined at 550° C. in air is slurried in deionized water (80 g). To this, an aqueous solution of tetraamminepalladium(II) bromide (0.48 g in 40 g of deionized water) is added with mixing over 30 min. The mixture stirs for another 2 h at 23° C. Water is removed by rotary evaporation at 50° C. The solids are air dried overnight, then under vacuum at 50° C. for 4 h to constant weight. The dried material contains 0.37 wt. % Pd and 2.06 wt. % Ti.

The dried solids are calcined in air by heating from 23° C. to 110° C. at 10° C./min. and holding at 110° C. for 4 h, then heating to 450° C. at 2° C./min. and holding at 450° C. for 12 h. The calcined solids are transferred to a quartz tube, heated to 50° C., and treated with 5% hydrogen (100 cm³/min) for 4 h. After hydrogen treatment, nitrogen is then passed through the solids for 1 h before cooling to 23° C.

### Production of Hydrogen Peroxide

### Examples 1-2

### Production of H₂O₂ with Polystyrene-Encapsulated Pd

A 100-mL Parr reactor is charged with polystyrene-encapsulated palladium catalyst (100 mg, see Examples A and B), deionized water (2.0 g), aqueous hydrogen bromide solution (0.22-0.24 g of a solution prepared by dissolving 0.115 g of 48 wt. % aqueous HBr in 100 g of deionized water), and methanol (16 g). The reactor is closed, flushed with nitrogen, and the contents are heated to 30° C. The reactor is charged with hydrogen (to 100 psig) and then a mixture of oxygen (4%) in nitrogen to 1290 psig. The reaction mixture is stirred magnetically at 30° C. for 1-2 h and is then cooled to 10° C. The percent hydrogen peroxide is determined by iodometric titration and is confirmed by liquid chromatography. Results appear in Table 1.

### Examples 3-5

### Production of H₂O₂ with Polystyrene-Encapsulated (Pd on TS-1)

The procedure of Examples 1-2 is generally followed except that the catalyst is palladium on titanium silicalite (TS-1) that has been encapsulated in polystyrene (see Ex. C). Results appear in Table 1.

### Example 6

### Production of H₂O₂ with Polystyrene-Encapsulated (Pd on TS-1)

The procedure of Examples 3-5 is followed except that 2.0 g of 0.1 M H₃PO₄ is used instead of the 2.0 g of deionized water in the first part of the procedure. Results appear in Table 1.

### Example 7

### Production of H₂O₂ with Terpolymer-Encapsulated (Pd on TS-1)

The procedure of Examples 1-2 is generally followed except that the catalyst is a palladium on titanium silicalite (TS-1) that has been encapsulated in a terpolymer of 4-tert-butylstyrene, N,N-dimethylacrylamide, and p-styryldiphenylphosphine (see Example D). Results appear in Table 1.

### Comparative Example 8

### Production of H₂O₂ Using 0.31 wt. % Pd on Spray-Dried TS-1

The procedure of Examples 1-2 is followed except that the catalyst is 0.31 wt. % Pd on titanium silicalite (TS-1), i.e., there is no polymer encapsulation (see Comparative Example E), and 50 mg of catalyst is used instead of 100 mg. Results appear in Table 1.

### Comparative Example 9

### Production of H₂O₂ Using 0.37 wt. % Pd on TS-1 Powder

A 100-mL Parr reactor is charged with Pd on TS-1 catalyst (50 mg, see Comparative Example F) deionized water (2.0 g), aqueous hydrogen bromide solution (0.20 g of a solution prepared by dissolving 0.115 g of 48 wt. % aqueous HBr in 100 g of deionized water), and methanol (16 g). The reactor is closed, flushed with nitrogen, and the contents are heated to 30° C. The reactor is charged with hydrogen (to 67 psig) and then a mixture of oxygen (4%) in nitrogen to 1270 psig. The reaction mixture is stirred magnetically at 30° C. for 1-2 h and is then cooled to 10° C. The percent hydrogen peroxide is determined by iodometric titration and is confirmed by liquid chromatography. Results appear in Table 1.

TABLE 1
Production of Hydrogen Peroxide

| | | Catalyst | HBr, | Time, | H₂O₂, |
|---|---|---|---|---|---|
| Ex. | Catalyst | Source | g | h | wt. % |
| 1 | PS-encap Pd | A | 0.24 | 2 | 0.13 |
| 2 | PS-encap Pd | B | 0.22 | 1 | 0.12 |
| 3 | PS-encap (Pd on TS-1) | C | 0.46 | 2 | 0.27 |
| 4 | PS-encap (Pd on TS-1) | C | 0.46 | 1 | 0.23 |
| 5 | PS-encap (Pd on TS-1) | C | 0.46 | 2 | 0.27 |
| 6 | PS-encap (Pd on TS-1) | C | 0.46 | 2 | 0.37 |
| 7 | terpolymer-encap (Pd on TS-1) | D | 0.45 | 2 | 0.14 |
| C8 | 0.31 wt. % Pd on spray-dried TS-1 | E | 0.22 | 1 | 0.22 |
| C9 | 0.37% Pd on TS-1 powder | F | 0.20 | 1 | 0.12 |

### Example 10 and Comparative Examples 11-12

### Filterability Comparison

The filterability of a polymer-encapsulated palladium catalyst is compared with palladium on TS-1 powder and palladium on spray-dried TS-1. Mixtures of Catalysts A, E, and F in methanol/water (8:2 by volume, 50 mL) containing 1 wt. % of solids are prepared. The mixtures are filtered at 320 psig through a 2-μm filter, and the time needed to collect 20-mL and 40-mL samples is recorded. Results appear in Table 2.

The results demonstrate that palladium on TS-1 powder (Comparative Example 11) tends to plug the filter, resulting in a tedious filtration. A spray-dried palladium on TS-1 catalyst, as expected, filters easily (see Comparative Example 12) because of its large particle size. In general, however, spray drying is expensive and time consuming. Polymer encapsulation provides an easy, inexpensive alternative to spray drying for making catalysts that are suitable for making hydrogen peroxide and are easily recovered from the reaction mixture.

TABLE 2
Filterability of Polymer-Encapsulated Catalysts

| | | | Time to collect | |
|---|---|---|---|---|
| | | Catalyst | (min) | |
| Ex. | Catalyst | Source | 20-mL | 40-mL |
| 10 | PS-encap Pd | A | <1 | <1 |
| C11 | 0.37% Pd on TS-1 powder | F | 15 | >60 |
| C12 | 0.31 wt. % Pd on spray-dried TS-1 | E | <1 | <1 |

The preceding examples are meant only as illustrations. The following claims define the invention.

1. A process which comprises reacting hydrogen and oxygen in a solvent in the presence of a catalyst comprising a polymer-encapsulated transition metal to produce hydrogen peroxide.

2. The process of claim 1 wherein the transition metal is one or more metals selected from Groups 7 to 11.

3. The process of claim 2 wherein the transition metal is selected from the group consisting of Fe, Co, Ni, Pd, Pt, Ru, Rh, Re, Au, and mixtures thereof.

4. The process of claim 3 wherein the transition metal is Pd.

5. The process of claim 3 wherein the transition metal is selected from the group consisting of Pd—Pt mixtures and Pd—Au mixtures.

6. The process of claim 1 wherein the polymer is selected from the group consisting of polystyrenics, polyolefins, polyureas, polyacrylics, polyurethanes, polyesters, polyamides, fluorinated polymers, polysaccharides, polypeptides, polynucleotides, and mixtures thereof.

7. The process of claim 6 wherein the polymer is polystyrene.

8. The process of claim 7 wherein the polymer-encapsulated transition metal is produced by polymerizing styrene in an aqueous suspension in the presence of a transition metal source.

9. The process of claim 6 wherein the polymer is a phosphorus-functionalized polystyrenic.

10. The process of claim 1 wherein the solvent is selected from the group consisting of water, oxygenated hydrocarbons, and mixtures thereof.

11. The process of claim 1 wherein the solvent is selected from the group consisting of water, C₁-C₄ alcohols, carbon dioxide, and mixtures thereof.

12. The process of claim 1 wherein the solvent is a mixture of methanol and water.

13. The process of claim 12 performed in the presence of a protic acid.

14. The process of claim 1 wherein the transition metal is supported prior to polymer encapsulation.

15. The process of claim 14 wherein the support is selected from the group consisting of silicas, aluminas, carbons, zeolites, clays, and organic polymers.

16. The process of claim 15 wherein the transition metal is palladium and the support is a titanium silicalite.

17. The process of claim 16 wherein the titanium silicalite is TS-1.

18. The process of claim 1 performed in the presence of a protic acid.

19. The process of claim 18 wherein the protic acid is hydrogen bromide.

20. The process of claim 18 wherein the protic acid is a mixture of hydrogen bromide and phosphoric acid.
